(19) United States
(12) Patent Application Publication
(10) Pub. No.: US 2026/0177428 A1
(43) Pub. Date: Jun. 25, 2026

(54) OPTICAL CORRECTION METHOD FOR SPECTRAL CALIBRATION OF HYPERSPECTRAL IMAGER

(71) Applicant: SHENZHEN INSTITUTE OF TECHNOLOGY INNOVATION, NIM, Shenzhen (CN)

(72) Inventors: Yingying XU, Shenzhen (CN); Pengfei WANG, Shenzhen (CN); Bowen LI, Shenzhen (CN); Qiuchen MA, Shenzhen (CN); Chi CHEN, Shenzhen (CN); Yulin QI, Shenzhen (CN)

(21) Appl. No.: 19/369,130

(22) Filed: Oct. 24, 2025

(30) Foreign Application Priority Data
Dec. 25, 2024 (CN) 202411918112.5

(51) Int. Cl. G01J 3/28

(52) U.S. Cl. CPC G01J 3/2823; G01J 2003/2836; G01J 2003/2859; G01J 2003/2879

(57) ABSTRACT

The disclosure provides an optical correction method for spectral calibration of a hyperspectral imager, including generating a measurement abnormality signal based on a comparative deviation degree value ZXj; acquiring an abnormal signal occurrence proportion BJ; generating a suspected wavelength shift signal; marking a measured spectral curve as an abnormal measured spectral curve based on a shift determination value CV; acquiring a quantity proportion value JK of abnormal measured spectral curves, and determining whether wavelength has shifted; obtaining data point transmission fluctuation parameters FG based on analysis of transmission data of data points; determining the data point transmission stability during a measurement of a standard light source by the hyperspectral imager; acquiring a period overlap degree value AS; comparing the period overlap degree value AS with a period overlap degree threshold, and determining whether the cause for the wavelength shift is poor data point transmission stability base on a comparison result.

This application claims priority to Chinese Patent Application No. 202411918112.5, filed on Dec. 25, 2024, which is incorporated by reference for all purposes as if fully set forth herein.

### FIELD OF THE INVENTION

The present disclosure relates to the field of optical calibration technologies, and in particular to an optical correction method for spectral calibration of a hyperspectral imager.

### DESCRIPTION OF THE RELATED ART

Hyperspectral imagers are capable of acquiring image information of target objects within a continuous spectral range and have broad application prospects. Meanwhile, to ensure normal operation of hyperspectral imagers, regular calibration is required. However, how to achieve faster calibration or improve calibration efficiency remains a challenge.

A Chinese patent application with publication number CN116228558A discloses a distortion correction method for a pushbroom-type hyperspectral imager, including: firstly, performing pushbroom imaging of a specific and identifiable target using a pushbroom-type hyperspectral imager to obtain a pushbroom image; obtaining coordinates of each distortion point on the pushbroom image through a corner point detection algorithm; obtaining distortion correction parameters using a method based on linear features along a pushbroom direction; obtaining distortion correction parameters using a cross-ratio invariance method in a direction perpendicular to the pushbroom direction; and correcting the pushbroom image based on the obtained distortion correction parameters combined with image grayscale correction.

In the above prior art, distortion correction parameters are obtained through a designed pushbroom method, but a specific analysis of the causes of distortion is lacking. Instead, distortion correction is performed directly. In practical situations, when the specific causes of distortion are unknown, performing distortion correction directly may solve current distortion problems, but cannot guarantee the continuity and effectiveness of such distortion correction.

Therefore, the present disclosure provides an optical correction method for spectral calibration of a hyperspectral imager.

### SUMMARY OF THE INVENTION

In order to overcome the deficiencies of the prior art and solve at least one technical problem proposed in the background section,
the technical solution adopted by the present disclosure to solve the above technical problem is an optical correction method for spectral calibration of a hyperspectral imager. The method includes:
step 1: performing multiple measurements on a standard light source by using a hyperspectral imager, and acquiring measurement data for each measurement; obtaining, based on the measurement data, comparative deviation data, where the measurement data includes measured values of wavelength points, and the comparative deviation data includes comparative deviation degree values ZXj; if a comparative deviation degree value ZXj is greater than or equal to a comparative deviation degree threshold, generating a measurement abnormality signal; acquiring an abnormal signal occurrence proportion BJ; and generating, based on the abnormal signal occurrence proportion BJ, a suspected wavelength shift signal;
step 2: acquiring, based on the generated suspected wavelength shift signal, a plurality of spectral curves obtained from the multiple measurements, and performing comparative analysis between each of the plurality of spectral curves and a standard spectral curve to obtain shift determination data, where the shift determination data includes shift determination values CV; marking a measured spectral curve as an abnormal measured spectral curve based on a shift determination value CV; acquiring a quantity proportion value JK of abnormal measured spectral curves, and determining, based on the quantity proportion value JK of the abnormal measured spectral curves, whether wavelength has shifted; and generating a shift signal;
step 3: acquiring, based on the shift signal, transmission time data of data points, where the transmission time data of the data points includes transmission time points of the data points; analyzing transmission data of the data points to obtain data point transmission fluctuation parameters FG; and determining, based on the data point transmission fluctuation parameters FG, data point transmission stability during the measurements of the standard light source by the hyperspectral imager; and
step 4: acquiring a detection period corresponding to an abnormal measured spectral curve; performing comparative analysis between the detection period corresponding to the abnormal measured spectral curve and a target time period; classifying the abnormal measured spectral curve based on a comparative analysis result; analyzing the classified abnormal measured spectral curve to obtain a period overlap degree value AS; comparing the period overlap degree value AS with a period overlap degree threshold; and determining, based on a comparison result, whether a cause for the wavelength shift is poor data point transmission stability.

As a further technical solution of the present disclosure, an acquisition method for the comparative deviation degree value ZXj includes:
comparing a measured value of a wavelength point with a standard value; and if the measured value of the wavelength point is not equal to the standard value, marking the wavelength point as an abnormal wavelength point; or if the measured value of the wavelength point is equal to the standard value, marking the wavelength point as a normal wavelength point;
acquiring proportion data of abnormal wavelength points, where the proportion data of the abnormal wavelength points includes a quantity proportion of the abnormal wavelength points and a total measurement deviation proportion; and
multiplying the quantity proportion of the abnormal wavelength points and the total measurement deviation proportion to obtain the comparative deviation degree value ZXj.

As a further technical solution of the present disclosure, an acquisition method for the quantity proportion of the abnormal wavelength points and the total measurement deviation proportion includes:
counting a number of all the wavelength points and a number of abnormal wavelength points among all the wavelength points; and performing ratio processing between the number of the abnormal wavelength points and the number of all the wavelength points to obtain the quantity proportion of the abnormal wavelength points; and
performing difference processing between measured values of the abnormal wavelength points and the standard value, and taking absolute values of differences to obtain measurement deviation values for the abnormal wavelength points; summing the measurement deviation values of all the abnormal wavelength points to obtain a total measurement deviation value of all the abnormal wavelength points; and performing ratio processing between the total measurement deviation value of all the abnormal wavelength points and the standard value to obtain a total measurement deviation proportion of all the abnormal wavelength points.

As a further technical solution of the present disclosure, the abnormal signal occurrence proportion BJ is obtained by performing ratio processing between a total number of occurrences of abnormal signals in the multiple measurements and a total number of the measurements of the standard light source by the hyperspectral imager.

The abnormal signal occurrence proportion BJ is compared with an abnormal signal occurrence proportion threshold:
if the abnormal signal occurrence proportion BJ is greater than or equal to the abnormal signal occurrence proportion threshold, a suspected wavelength shift signal is generated; or
if the abnormal signal occurrence proportion BJ is less than the abnormal signal occurrence proportion threshold, no suspected wavelength shift signal is generated.

As a further technical solution of the present disclosure, an acquisition method for the shift determination value CV includes:
acquiring an area deviation ratio of the spectral curve, an abnormal peak quantity ratio of the spectral curve, and an abnormal peak position distance deviation ratio of the spectral curve;
performing data processing on the area deviation ratio of the spectral curve, the abnormal peak quantity ratio of the spectral curve, and the abnormal peak position distance deviation ratio of the spectral curve to obtain the shift determination value CV; comparing the obtained shift determination value CV with a shift determination threshold KU, and if the shift determination value CV is greater than or equal to the shift determination threshold, marking the measured spectral curve as an abnormal measured spectral curve;
counting a number of abnormal measured spectral curves among measured spectral curves, and performing ratio processing between the number of the abnormal measured spectral curves and a number of the measured spectral curves to obtain the quantity proportion value JK of the abnormal measured spectral curves; and
if the quantity proportion value JK of the abnormal measured spectral curves is greater than or equal to a quantity proportion threshold of the abnormal measured spectral curves, generating a shift signal; if the quantity proportion value JK of the abnormal measured spectral curves is less than the quantity proportion threshold of the abnormal measured spectral curves, not generating a shift signal.

As a further technical solution of the present disclosure, an acquisition method for the area deviation ratio Ai of the spectral curve, the abnormal peak quantity ratio Gi of the spectral curve, and the abnormal peak position distance deviation ratio Hi of the spectral curve includes:
comparing the measured spectral curve with the standard spectral curve in an X-Y two-dimensional coordinate system; and performing ratio processing between an area enclosed between the measured spectral curve and the standard spectral curve and an area enclosed between the standard spectral curve and an X-axis to obtain the area deviation ratio Ai of the spectral curve;
acquiring, based on the X-Y two-dimensional coordinate system, position point coordinates of each peak in the measured spectral curve, and numbering peak points; similarly, acquiring position point coordinates of each peak in the standard spectral curve, and also numbering peak points;
matching the coordinates of each peak in the measured spectral curve with the coordinates of a correspondingly numbered peak in the standard spectral curve, and if the coordinates of the peak in the measured spectral curve do not match the coordinates of the correspondingly numbered peak in the standard spectral curve, marking the peak in the measured spectral curve as an abnormal peak; counting a number of abnormal peaks among peaks corresponding to the measured spectral curve as well as a number of the peaks in the measured spectral curve; and performing ratio processing between the number of the abnormal peaks and the number of the peaks in the measured spectral curve to obtain the abnormal peak quantity ratio Gi of the spectral curve; and
obtaining, based on the coordinates of the abnormal peaks and the coordinates of the correspondingly numbered peaks in the standard spectral curve, deviation distances between the abnormal peaks and the correspondingly numbered peaks in the standard spectral curve; summing the deviation distances between all the abnormal peaks and the correspondingly numbered peaks in the standard spectral curve to obtain a total deviation distance between all the abnormal peaks and the correspondingly numbered peaks in the standard spectral curve; and performing ratio processing between the total deviation distance between all the abnormal peaks and the correspondingly numbered peaks in the standard spectral curve and a total deviation distance threshold between the abnormal peaks and the correspondingly numbered peaks in the standard spectral curve to obtain the abnormal peak position distance deviation ratio Hi of the spectral curve.

As a further technical solution of the present disclosure, an acquisition method for the data point transmission fluctuation parameter FG includes:
analyzing the transmission data of the data points to obtain a quantity proportion of target time periods and a time deviation ratio of the target time periods; and multiplying the quantity proportion of the target time periods and the time deviation ratio of the target time periods to obtain the data point transmission fluctuation parameter FG.

Comparing the data point transmission fluctuation parameter FG with a data point transmission fluctuation parameter threshold includes the following specific comparison processes:
presetting the data point transmission fluctuation parameter threshold as FJ; and
indicating, if the data point transmission fluctuation parameter FG is greater than or equal to the data point transmission fluctuation parameter threshold FJ, that the data point transmission stability during the measurements of the standard light source by the hyperspectral imager is poor; or
indicating, if the data point transmission fluctuation parameter FG is less than the data point transmission fluctuation parameter threshold FJ, that the data point transmission stability during the measurements of the standard light source by the hyperspectral imager is good.

As a further technical solution of the present disclosure, an acquisition method for the quantity proportion of the target time periods and the time deviation ratio of the target time periods includes:
arranging the data points sequentially according to the transmission time points, extracting interval time lengths between the data points, and consolidating all the extracted interval time lengths into an interval time length data set; selecting, from the interval time length data set, an interval time length with a highest frequency of occurrence, and marking the interval time length as a reference time length; matching all the interval time lengths in the interval time length data set separately with the reference time length, and if there is no match, marking interval time periods, corresponding to interval time lengths that do not match the reference time length, as the target time periods;
counting a number of the target time periods and a number of the interval time lengths, and performing ratio processing between the number of the target time periods and the number of the interval time lengths to obtain the quantity proportion of the target time periods; and
performing difference processing between the interval time lengths corresponding to all the target time periods and the reference time length separately, and summing absolute values of differences to obtain a time deviation value of the target time periods; and performing ratio processing between the time deviation value of the target time periods and the reference time length to obtain the time deviation ratio of the target time periods.

As a further technical solution of the present disclosure, an acquisition method for the period overlap degree value AS includes:
performing comparative analysis between the detection period corresponding to the abnormal measured spectral curve and the target time period; classifying, based on the comparative analysis result, the abnormal measured spectral curve as a highly overlapping curve, a moderately overlapping curve, or a non-overlapping curve; counting a number of highly overlapping curves and a number of abnormal measured spectral curves, and performing ratio processing between the number of the highly overlapping curves and the number of the abnormal measured spectral curves to obtain a quantity proportion of the highly overlapping curves;
counting a number of moderately overlapping curves, and performing ratio processing between the number of the moderately overlapping curves and the number of the abnormal measured spectral curves to obtain a quantity proportion of the moderately overlapping curves;
acquiring a total overlapping period between detection periods corresponding to all the moderately overlapping curves and target time periods, extracting a time length of the total overlapping period and a time length of the target time periods, and performing ratio processing between the time length of the total overlapping period and the time length of the target time periods to obtain a time length proportion of an overlapping period; and
multiplying the obtained quantity proportion of the highly overlapping curves, the quantity proportion of the moderately overlapping curves, and the time length proportion of the overlapping period to obtain the period overlap degree value AS.

As a further technical solution of the present disclosure, comparing the period overlap degree value AS with the period overlap degree threshold, and determining, based on the comparison result, whether the cause for the wavelength shift is poor data point transmission stability, specifically include:
indicating, if the period overlap degree value AS is greater than or equal to the period overlap degree threshold, that the wavelength shift is caused by poor data point transmission stability; or
indicating, if the period overlap degree value AS is less than the period overlap degree threshold, that poor data point transmission stability do not cause the wavelength shift.

The beneficial effects of the present disclosure are as follows.

1. According to the present disclosure, by acquiring measurement data and performing a comparative analysis between the measurement data and the standard value, anomaly marking is performed on the wavelength points based on the analysis result. Moreover, through the number of abnormal wavelength points as well as the deviation values between the measured values corresponding to the abnormal wavelength points and the standard value, analysis is performed during the measurement process to determine whether the wavelength is suspected of having undergone a shift. Further analysis is performed in combination with multiple measurement results. If there are multiple signs of wavelength shift during multiple measurement processes, a suspected wavelength shift signal is generated. The advantage lies in not directly conducting a comprehensive analysis of whether wavelength has shifted, but rather continuing the analysis after signs of wavelength shift exist and making a final determination of whether wavelength has shifted. If there are no signs of wavelength shift, calibration proceeds to the next aspect of spectral calibration, thereby reducing the time required for spectral calibration of the hyperspectral imager and improving calibration efficiency.

2. According to the present disclosure, after generating the suspected wavelength shift signal, the measured spectral curve is compared with the standard spectral curve, and analysis is performed based on the obtained area deviation ratio Ai of the spectral curve, abnormal peak quantity ratio Gi of the spectral curve, and abnormal peak position distance deviation ratio Hi of the spectral curve. Based on the analysis result, the spectral curves are marked, and the spectral curves corresponding to wavelength shift occurrence are marked. Through analysis of the marked spectral curves corresponding to wavelength shift occurrence, it is determined that their wavelengths have truly undergone a shift. The essence lies in performing analysis by combining spectral curves obtained from multiple measurements, thereby improving the accuracy of the hyperspectral imager in spectral calibration.

3. According to the present disclosure, after generating the wavelength shift signal, analysis of the wavelength causes is performed. A preferred aspect of cause analysis is the transmission stability of optical data within the hyperspectral imager. The reason is that without confirming that the hyperspectral imager's own components are normal or data transmission is normal, directly conducting deep-level cause analysis may increase the complexity of analysis, such as parameter settings. If the hyperspectral imager's own component issues or data transmission problems are not resolved, even if deep-level causes are identified, effective adjustments may not be possible due to these problems.

4. According to the present disclosure, in cases where data point transmission stability is poor, the degree of overlap between the time periods of poor data transmission stability during each measurement process and the wavelength shift detection time periods is analyzed. Through the degree of overlap, the impact of poor data transmission stability on wavelength shift is analyzed, and the cause of wavelength shift (whether it is due to poor data transmission stability) is determined.

### BRIEF DESCRIPTION OF THE DRAWINGS

The present disclosure is further illustrated below with reference to the accompanying drawings.

FIG. 1 is a flowchart of Example 1 according to the present disclosure;

FIG. 2 is a flowchart of a data acquisition method in Example 1 according to the present disclosure; and

FIG. 3 is a flowchart of Example 2 according to the present disclosure.

### DETAILED DESCRIPTION OF THE PREFERRED EMBODIMENTS

To make the technical means, creative features, and purposes and effects achieved by the present disclosure easy to understand, the present disclosure is further described hereinafter in conjunction with specific embodiments.

### Example 1

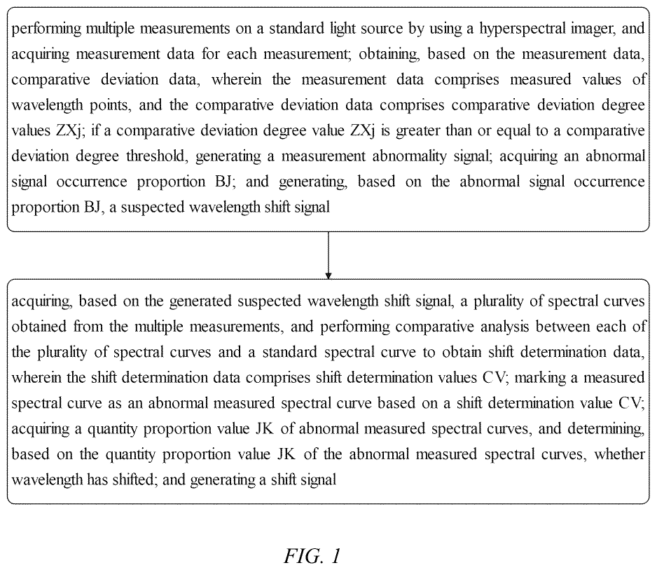

As shown in FIG. 1, an optical correction method for spectral calibration of a hyperspectral imager described in this example of the present disclosure includes the following steps.

In step 1, multiple measurements are performed on a standard light source by using a hyperspectral imager, and measurement data for each measurement is acquired; comparative deviation data is obtained based on the measurement data, where the measurement data includes measured values of wavelength points, and the comparative deviation data includes comparative deviation degree values ZXj; a comparative deviation degree value ZXj is compared with a comparative deviation degree threshold; if the comparative deviation degree value ZXj is greater than or equal to the comparative deviation degree threshold, then a measurement abnormality signal is generated, and abnormal signal occurrence proportion BJ is obtained based on analysis of the measurement abnormality signal; if the abnormal signal occurrence proportion BJ is greater than or equal to an abnormal signal occurrence proportion threshold, then a suspected wavelength shift signal is generated.

Specifically, a measured value of a wavelength point is compared with a standard value; and if the measured value of the wavelength point is not equal to the standard value, the wavelength point is marked as an abnormal wavelength point; or if the measured value of the wavelength point is equal to the standard value, the wavelength point is marked as a normal wavelength point.

Proportion data of abnormal wavelength points is acquired, where the proportion data of the abnormal wavelength points includes a quantity proportion of the abnormal wavelength points and a total measurement deviation proportion.

The quantity proportion of the abnormal wavelength points and the total measurement deviation proportion are multiplied to obtain the comparative deviation degree value ZXj.

An acquisition method for the quantity proportion of the abnormal wavelength points and the total measurement deviation proportion is as follows.

A number of all the wavelength points and a number of abnormal wavelength points among all the wavelength points are counted; and ratio processing is performed between the number of the abnormal wavelength points and the number of all the wavelength points to obtain the quantity proportion of the abnormal wavelength points.

Difference processing is performed between measured values of the abnormal wavelength points and the standard value, and absolute values of differences are taken to obtain measurement deviation values for the abnormal wavelength points; the measurement deviation values of all the abnormal wavelength points are summed to obtain a total measurement deviation value of all the abnormal wavelength points; and ratio processing is performed between the total measurement deviation value of all the abnormal wavelength points and the standard value to obtain a total measurement deviation proportion of all the abnormal wavelength points.

It should be noted that the purpose and significance of acquiring the quantity proportion of abnormal wavelength points and the total measurement deviation proportion lies in comparing the measured values of wavelength points with a standard value to determine the number of abnormal wavelength points, because the inequality between the measured values of the wavelength points and the standard value can preliminarily reflect signs of wavelength shift occurrence. Meanwhile, combined with the number of abnormal wavelength points as well as the deviation values between the measured values corresponding to the abnormal wavelength points and the standard value, it is further accurately determined whether there is a high possibility of wavelength shift occurrence.

The obtained comparative deviation degree value ZXj is compared with the comparative deviation degree threshold. The specific comparison process is as follows.

The comparative deviation degree threshold is preset as ZXc.

If the comparative deviation degree value ZXj is greater than or equal to the comparative deviation degree threshold ZXc, a measurement abnormality signal is generated.

If the comparative deviation degree value ZXj is less than the comparative deviation degree threshold ZXc, a measurement normal signal is generated.

The total number of abnormal signal occurrences in multiple measurements and the total number of measurements of the standard light source by the hyperspectral imager are counted, and ratio processing is performed on the total number of abnormal signal occurrences and the total number of measurements of the standard light source by the hyperspectral imager to obtain the abnormal signal occurrence proportion BJ.

The abnormal signal occurrence proportion BJ is compared with an abnormal signal occurrence proportion threshold:

If the abnormal signal occurrence proportion BJ is greater than or equal to the abnormal signal occurrence proportion threshold, a suspected wavelength shift signal is generated.

If the abnormal signal occurrence proportion BJ is less than the abnormal signal occurrence proportion threshold, no suspected wavelength shift signal is generated.

It should be noted that the concept of step 1 is as follows: By acquiring measurement data and performing comparative analysis between the measurement data and the standard value, anomaly marking is performed on the wavelength points based on the analysis result. Moreover, through the number of abnormal wavelength points as well as the deviation values between the measured values corresponding to the abnormal wavelength points and the standard value, analysis is performed during the measurement process to determine whether the wavelength is suspected of having undergone a shift. Further analysis is performed in combination with multiple measurement results. If there are multiple signs of wavelength shift during multiple measurement processes, a suspected wavelength shift signal is generated. The advantage lies in not directly conducting a comprehensive analysis of whether wavelength has shifted, but rather continuing the analysis after signs of wavelength shift exist and making a final determination of whether wavelength has shifted. If there are no signs of wavelength shift, calibration proceeds to the next aspect of spectral calibration, thereby reducing the time required for spectral calibration of the hyperspectral imager and improving calibration efficiency.

In step 2, a plurality of spectral curves, which are obtained from the multiple measurements on the standard light source by the hyperspectral imager, is acquired based on the generated suspected wavelength shift signal, and each spectral curve is marked as a measured spectral curve; comparative analysis is performed between the measured spectral curves and the standard spectral curve to obtain shift determination data, where the shift determination data includes shift determination values CV; if a shift determination value CV is greater than or equal to a shift determination threshold, the measured spectral curve is marked as an abnormal measured spectral curve; a quantity proportion value JK of abnormal measured spectral curves is obtained based on analysis of the abnormal measured spectral curves, and the quantity proportion value JK of the abnormal measured spectral curves is compared with a quantity proportion threshold of the abnormal measured spectral curves to determine whether wavelength has shifted. If a shift has occurred, a shift signal is generated.

An acquisition method for the shift determination value CV is as follows.

The area deviation ratio of the spectral curve, the abnormal peak quantity ratio of the spectral curve, and the abnormal peak position distance deviation ratio of the spectral curve are marked as Ai, Gi, and Hi, respectively.

Data processing is performed on the area deviation ratio Ai of the spectral curve, the abnormal peak quantity ratio Gi of the spectral curve, and the abnormal peak position distance deviation ratio Hi of the spectral curve through the formula

$$CV = \frac{s 1 \times Ai + s 2 \times Gi + s 3 \times Hi}{s 1 + s 2 + s 3}$$

to obtain the shift determination value CV, where s1, s2, and s3 are all preset proportion coefficients.

The obtained shift determination value CV is compared with the shift determination threshold.

The preset shift determination threshold is denoted as KU.

If the shift determination value CV is greater than or equal to the shift determination threshold KU, the measured spectral curve is marked as an abnormal measured spectral curve.

If the shift determination value CV is less than the shift determination threshold KU, the measured spectral curve is marked as a normal measured spectral curve.

A number of abnormal measured spectral curves among measured spectral curves is counted, and ratio processing is performed between the number of the abnormal measured spectral curves and a number of the measured spectral curves to obtain the quantity proportion value JK of the abnormal measured spectral curves.

If the quantity proportion value JK of the abnormal measured spectral curves is greater than or equal to a quantity proportion threshold of the abnormal measured spectral curves, a shift signal is generated; if the quantity proportion value JK of the abnormal measured spectral curves is less than the quantity proportion threshold of the abnormal measured spectral curves, no shift signal is generated.

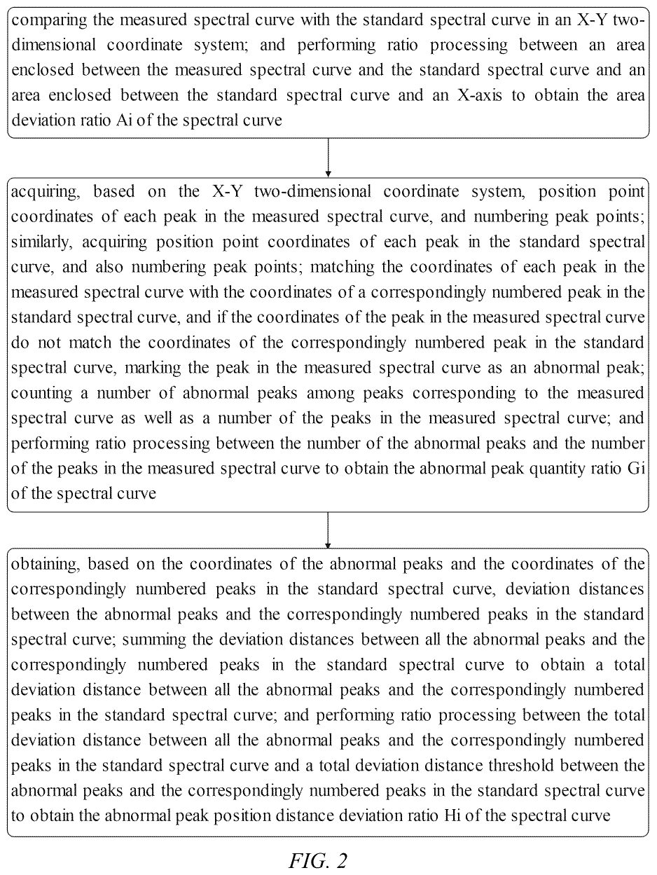

As shown in FIG. 2, an acquisition method for the area deviation ratio Ai of the spectral curve, the abnormal peak quantity ratio Gi of the spectral curve, and the abnormal peak position distance deviation ratio Hi of the spectral curve is as follows.

The measured spectral curve is compared with the standard spectral curve in an X-Y two-dimensional coordinate system; and ratio processing is performed between an area enclosed between the measured spectral curve and the standard spectral curve and an area enclosed between the standard spectral curve and an X-axis to obtain the area deviation ratio Ai of the spectral curve.

Position point coordinates of each peak in the measured spectral curve are acquired based on the X-Y two-dimensional coordinate system, and peak points are numbered; similarly, position point coordinates of each peak in the standard spectral curve are acquired, and peak points are also numbered.

It should be noted that the numbering of each peak in the measured spectral curve corresponds to the same numbering of each peak in the standard spectral curve.

The coordinates of each peak in the measured spectral curve are matched with the coordinates of a correspondingly numbered peak in the standard spectral curve, and if the coordinates of the peak in the measured spectral curve do not match the coordinates of the correspondingly numbered peak in the standard spectral curve, the peak in the measured spectral curve is marked as an abnormal peak; a number of abnormal peaks among peaks corresponding to the measured spectral curve as well as a number of the peaks in the measured spectral curve are counted; and ratio processing is performed between the number of the abnormal peaks and the number of the peaks in the measured spectral curve to obtain the abnormal peak quantity ratio Gi of the spectral curve.

Deviation distances between the abnormal peaks and the correspondingly numbered peaks in the standard spectral curve are obtained based on the coordinates of the abnormal peaks and the coordinates of the correspondingly numbered peaks in the standard spectral curve; the deviation distances between all the abnormal peaks and the correspondingly numbered peaks in the standard spectral curve are summed to obtain a total deviation distance between all the abnormal peaks and the correspondingly numbered peaks in the standard spectral curve; and ratio processing is performed between the total deviation distance between all the abnormal peaks and the correspondingly numbered peaks in the standard spectral curve and a total deviation distance threshold between the abnormal peaks and the correspondingly numbered peaks in the standard spectral curve to obtain the abnormal peak position distance deviation ratio Hi of the spectral curve.

It should be noted that the significance of acquiring the area deviation ratio Ai of the spectral curve, the abnormal peak quantity ratio Gi of the spectral curve, and the abnormal peak position distance deviation ratio Hi of the spectral curve lies in that the intuitive data for determining wavelength shift includes spectral curve area deviation, the quantity of spectral curve abnormal peaks, and spectral curve abnormal peak position distance deviation. However, wavelength shift cannot be accurately determined solely from the quantity of spectral curve abnormal peaks, because in the case where the quantity of abnormal peaks is large, if the area deviation of the spectral curve is small, that is, the systematic deviation between spectral curves is small, or when the spectral curve abnormal peak position distance deviation is small, it is impossible to accurately determine whether wavelength shift exists.

It should be noted that the concept of step 2 is as follows: After generating the suspected wavelength shift signal, the measured spectral curve is compared with the standard spectral curve, and analysis is performed based on the obtained area deviation ratio Ai of the spectral curve, abnormal peak quantity ratio Gi of the spectral curve, and abnormal peak position distance deviation ratio Hi of the spectral curve. Based on the analysis result, the spectral curves are marked, and the spectral curves corresponding to wavelength shift occurrence are marked. Through analysis of the marked spectral curves corresponding to wavelength shift occurrence, it is determined that their wavelengths have truly undergone a shift. The essence lies in performing analysis by combining spectral curves obtained from multiple measurements, thereby improving the accuracy of the hyperspectral imager in spectral calibration.

### Example 2

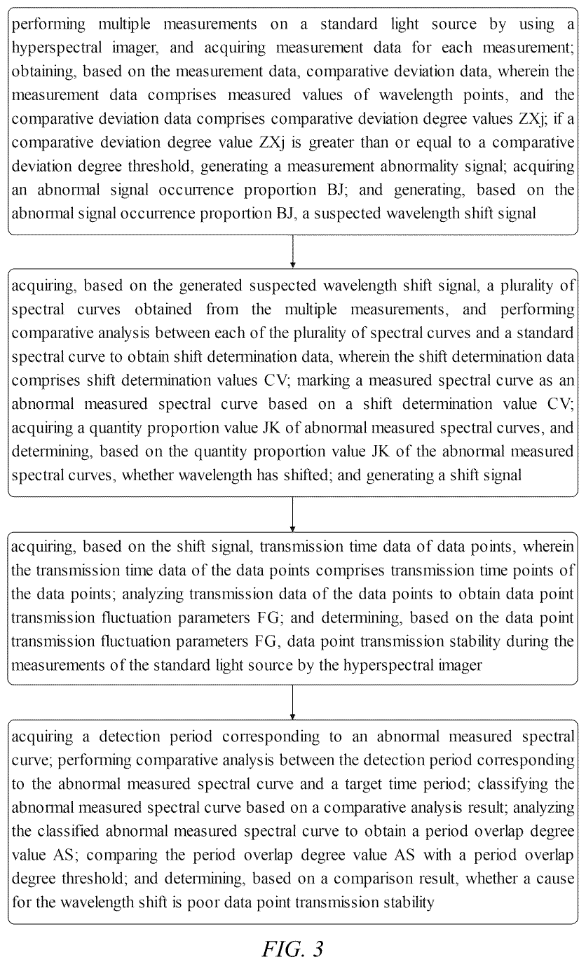

As shown in FIG. 3, based on Example 1, an optical correction method for spectral calibration of a hyperspectral imager described in this example of the present disclosure includes the following steps.

In step 3, transmission time data of data points during the measurements of the standard light source by the hyperspectral imager is acquired based on the generated shift signal, where the transmission time data of the data points includes transmission time points of the data points; transmission data of the data points is analyzed to obtain data point transmission fluctuation parameters FG; and data point transmission stability during the measurements of the standard light source by the hyperspectral imager is determined based on the data point transmission fluctuation parameters FG.

Specifically, the transmission data of the data points is analyzed to obtain a quantity proportion of target time periods and a time deviation ratio of the target time periods; and the quantity proportion of the target time periods and the time deviation ratio of the target time periods are multiplied to obtain the data point transmission fluctuation parameter FG.

The data point transmission fluctuation parameter FG is compared with a data point transmission fluctuation parameter threshold. The specific comparison process is as follows.

The data point transmission fluctuation parameter threshold is preset as FJ.

If the data point transmission fluctuation parameter FG is greater than or equal to the data point transmission fluctuation parameter threshold FJ, it is indicated that the data point transmission stability during the measurements of the standard light source by the hyperspectral imager is poor.

If the data point transmission fluctuation parameter FG is less than the data point transmission fluctuation parameter threshold FJ, it is indicated that the data point transmission stability during the measurements of the standard light source by the hyperspectral imager is good.

An acquisition method for the quantity proportion of the target time periods and the time deviation ratio of the target time periods is as follows.

The data points are sequentially arranged according to the transmission time points, interval time lengths between the data points are extracted, and all the extracted interval time lengths are consolidated into an interval time length data set; an interval time length with a highest frequency of occurrence is selected from the interval time length data set, and the interval time length is marked as a reference time length; all the interval time lengths in the interval time length data set are matched separately with the reference time length, and if there is no match, interval time periods, corresponding to interval time lengths that do not match the reference time length, are marked as the target time periods.

A number of the target time periods and a number of the interval time lengths are counted, and ratio processing is performed between the number of the target time periods and the number of the interval time lengths to obtain the quantity proportion of the target time periods.

Difference processing is performed between the interval time lengths corresponding to all the target time periods and the reference time length separately, and absolute values of differences are summed to obtain a time deviation value of the target time periods; and ratio processing is performed between the time deviation value of the target time periods and the reference time length to obtain the time deviation ratio of the target time periods.

It should be noted that the concept of step 3 is as follows: After generating the wavelength shift signal, analysis of the wavelength causes is performed. A preferred aspect of cause analysis is the transmission stability of optical data within the hyperspectral imager. The reason is that without confirming that the hyperspectral imager's own components are normal or data transmission is normal, directly conducting deep-level cause analysis may increase the complexity of analysis, such as parameter settings. If the hyperspectral imager's own component issues or data transmission problems are not resolved, even if deep-level causes are identified, effective adjustments may not be possible due to these problems.

In step 4, based on poor data point transmission stability during the measurements of the standard light source by the hyperspectral imager, a detection period corresponding to an abnormal measured spectral curve is acquired; comparative analysis is performed between the detection period corresponding to the abnormal measured spectral curve and a target time period; the abnormal measured spectral curve is classified based on a comparative analysis result; the classified abnormal measured spectral curve is analyzed to obtain a period overlap degree value AS; the period overlap degree value AS is compared with a period overlap degree threshold; and whether a cause for the wavelength shift is poor data point transmission stability is determined based on a comparison result.

It should be noted that a detection period corresponding to an abnormal measured spectral curve is a time period between a start time and an end time of a detection process corresponding to the abnormal measured spectral curve.

Comparative analysis is performed between the detection periods corresponding to the abnormal measured spectral curves and the target time periods, and the abnormal measured spectral curves are classified based on the comparative analysis results. The specific process is as follows.

If both a detection start time point and an end time point of a detection period corresponding to an abnormal measured spectral curve are within a target time period, the abnormal measured spectral curve is marked as a highly overlapping curve.

If both the detection start time point and the end time point of the detection period corresponding to the abnormal measured spectral curve are not within the target time period, the abnormal measured spectral curve is marked as a highly overlapping curve.

If neither the detection start time point nor the end time point of the detection period corresponding to the abnormal measured spectral curve is within the target time period, a specific analysis is performed.

If both the detection start time point and the end time point of the detection period corresponding to the abnormal measured spectral curve are before a start time point or after an end time point of the target time period, the abnormal measured spectral curve is marked as a non-overlapping curve.

If the detection start time point of the detection period corresponding to the abnormal measured spectral curve is before the start time point of the target time period and the end time point of the detection period corresponding to the abnormal measured spectral curve is after the end time point of the target time period, the abnormal measured spectral curve is marked as a moderately overlapping curve.

A number of highly overlapping curves and a number of the abnormal measured spectral curves are counted, and ratio processing is performed between the number of the highly overlapping curves and the number of the abnormal measured spectral curves to obtain a quantity proportion of the highly overlapping curves.

A number of moderately overlapping curves is counted, and ratio processing is performed between the number of the moderately overlapping curves and the number of the abnormal measured spectral curves to obtain a quantity proportion of the moderately overlapping curves.

A total overlapping period between detection periods corresponding to all the moderately overlapping curves and the target time periods is acquired, a time length of the total overlapping period and a time length of the target time periods are extracted, and ratio processing is performed between the time length of the total overlapping period and the time length of the target time periods to obtain a time length proportion of an overlapping period.

The obtained quantity proportion of the highly overlapping curves, the quantity proportion of the moderately overlapping curves, and the time length proportion of the overlapping period are multiplied to obtain the period overlap degree value AS.

The obtained period overlap degree value AS is compared with the period overlap degree threshold.

If the period overlap degree value AS is greater than or equal to the period overlap degree threshold, it is indicated that the wavelength shift is caused by poor data point transmission stability.

If the period overlap degree value AS is less than the period overlap degree threshold, it is indicated that poor data point transmission stability do not cause the wavelength shift.

It should be noted that the concept of step 4 is as follows: In cases where data point transmission stability is poor, the degree of overlap between the time periods of poor data transmission stability during each measurement process and the wavelength shift detection time periods is analyzed. Through the degree of overlap, the impact of poor data transmission stability on wavelength shift is analyzed, and the cause of wavelength shift is determined.

The above shows and describes the basic principles, main features, and advantages of the present disclosure. Those skilled in the art should understand that the present disclosure is not limited to the above examples. The above examples and descriptions in the specification only illustrate the principles of the present disclosure. Without departing from the spirit and scope of the present disclosure, the present disclosure will have various changes and improvements, and these changes and improvements all fall within the scope of the present disclosure for which protection is claimed. The scope of protection claimed by the present disclosure is defined by the appended claims and equivalents thereof.

1. An optical correction method for spectral calibration of a hyperspectral imager, comprising:
step 1: performing multiple measurements on a standard light source by using a hyperspectral imager, and acquiring measurement data for each measurement; obtaining, based on the measurement data, comparative deviation data, wherein the measurement data comprises measured values of wavelength points, and the comparative deviation data comprises comparative deviation degree values ZXj; if a comparative deviation degree value ZXj is greater than or equal to a comparative deviation degree threshold, generating a measurement abnormality signal; acquiring an abnormal signal occurrence proportion BJ; and generating, based on the abnormal signal occurrence proportion BJ, a suspected wavelength shift signal;
step 2: acquiring, based on the generated suspected wavelength shift signal, a plurality of spectral curves obtained from the multiple measurements, and performing comparative analysis between each of the plurality of spectral curves and a standard spectral curve to obtain shift determination data, wherein the shift determination data comprises shift determination values CV; marking a measured spectral curve as an abnormal measured spectral curve based on a shift determination value CV; acquiring a quantity proportion value JK of abnormal measured spectral curves, and determining, based on the quantity proportion value JK of the abnormal measured spectral curves, whether wavelength has shifted; and generating a shift signal;
step 3: acquiring, based on the shift signal, transmission time data of data points, wherein the transmission time data of the data points comprises transmission time points of the data points; analyzing transmission data of the data points to obtain data point transmission fluctuation parameters FG; and determining, based on the data point transmission fluctuation parameters FG, data point transmission stability during the measurements of the standard light source by the hyperspectral imager;
arranging the data points sequentially according to the transmission time points, extracting interval time lengths between the data points, marking the interval time length with a highest frequency of occurrence as a reference time length, marking interval time periods, corresponding to interval time lengths that do not match the reference time length, as the target time periods; performing difference processing between the interval time lengths corresponding to all the target time periods and the reference time length separately, and summing absolute values of differences to obtain a time deviation value of the target time periods, the time deviation ratio of the target time periods is the ratio of the time deviation value of the target time periods and the reference time length; and
step 4: acquiring a detection period corresponding to an abnormal measured spectral curve; performing comparative analysis between the detection period corresponding to the abnormal measured spectral curve and a target time period; classifying the abnormal measured spectral curve based on a comparative analysis result; analyzing the classified abnormal measured spectral curve to obtain a period overlap degree value AS; comparing the period overlap degree value AS with a period overlap degree threshold; and determining, based on a comparison result, whether a cause for the wavelength shift is poor data point transmission stability.

2. The optical correction method for spectral calibration of a hyperspectral imager according to claim 1, wherein an acquisition method for the comparative deviation degree value ZXj comprises:
comparing a measured value of a wavelength point with a standard value; and if the measured value of the wavelength point is not equal to the standard value, marking the wavelength point as an abnormal wavelength point; or if the measured value of the wavelength point is equal to the standard value, marking the wavelength point as a normal wavelength point;
acquiring proportion data of abnormal wavelength points, wherein the proportion data of the abnormal wavelength points comprises a quantity proportion of the abnormal wavelength points and a total measurement deviation proportion; and
multiplying the quantity proportion of the abnormal wavelength points and the total measurement deviation proportion to obtain the comparative deviation degree value ZXj; and
an acquisition method for the total measurement deviation proportion comprises:
performing difference processing between measured values of the abnormal wavelength points and the standard value, and taking absolute values of differences to obtain measurement deviation values for the abnormal wavelength points; summing the measurement deviation values of all the abnormal wavelength points to obtain a total measurement deviation value of all the abnormal wavelength points; and performing ratio processing between the total measurement deviation value of all the abnormal wavelength points and the standard value to obtain a total measurement deviation proportion of all the abnormal wavelength points.

3. The optical correction method for spectral calibration of a hyperspectral imager according to claim 2, wherein an acquisition method for the quantity proportion of the abnormal wavelength points comprises:
counting a number of all the wavelength points and a number of abnormal wavelength points among all the wavelength points; and performing ratio processing between the number of the abnormal wavelength points and the number of all the wavelength points to obtain the quantity proportion of the abnormal wavelength points.

4. The optical correction method for spectral calibration of a hyperspectral imager according to claim 1, wherein the abnormal signal occurrence proportion BJ is obtained by performing ratio processing between a total number of occurrences of abnormal signals in the multiple measurements and a total number of the measurements of the standard light source by the hyperspectral imager; and
the abnormal signal occurrence proportion BJ is compared with an abnormal signal occurrence proportion threshold:
if the abnormal signal occurrence proportion BJ is greater than or equal to the abnormal signal occurrence proportion threshold, a suspected wavelength shift signal is generated; or
if the abnormal signal occurrence proportion BJ is less than the abnormal signal occurrence proportion threshold, no suspected wavelength shift signal is generated.

5. The optical correction method for spectral calibration of a hyperspectral imager according to claim 1, wherein an acquisition method for the shift determination value CV comprises:
acquiring an area deviation ratio Ai of the spectral curve, an abnormal peak quantity ratio Gi of the spectral curve, and an abnormal peak position distance deviation ratio Hi of the spectral curve;
performing data processing on the area deviation ratio Ai of the spectral curve, the abnormal peak quantity ratio Gi of the spectral curve, and the abnormal peak position distance deviation ratio Hi of the spectral curve through the formula
$$CV = \frac{s 1 \times Ai + s 2 \times Gi + s 3 \times Hi}{s 1 + s 2 + s 3}$$
to obtain the shift determination value CV, where s1, s2, and s3 are all preset proportion coefficients; comparing the obtained shift determination value CV with a shift determination threshold KU, and if the shift determination value CV is greater than or equal to the shift determination threshold, marking the measured spectral curve as an abnormal measured spectral curve;
counting a number of abnormal measured spectral curves among measured spectral curves, and performing ratio processing between the number of the abnormal measured spectral curves and a number of the measured spectral curves to obtain the quantity proportion value JK of the abnormal measured spectral curves; and
if the quantity proportion value JK of the abnormal measured spectral curves is greater than or equal to a quantity proportion threshold of the abnormal measured spectral curves, generating a shift signal; if the quantity proportion value JK of the abnormal measured spectral curves is less than the quantity proportion threshold of the abnormal measured spectral curves, not generating a shift signal; and
an acquisition method for the abnormal peak position distance deviation ratio Hi of the spectral curve comprises:
obtaining, based on the coordinates of the abnormal peaks and the coordinates of the correspondingly numbered peaks in the standard spectral curve, deviation distances between the abnormal peaks and the correspondingly numbered peaks in the standard spectral curve; summing the deviation distances between all the abnormal peaks and the correspondingly numbered peaks in the standard spectral curve to obtain a total deviation distance between all the abnormal peaks and the correspondingly numbered peaks in the standard spectral curve; and performing ratio processing between the total deviation distance between all the abnormal peaks and the correspondingly numbered peaks in the standard spectral curve and a total deviation distance threshold between the abnormal peaks and the correspondingly numbered peaks in the standard spectral curve to obtain the abnormal peak position distance deviation ratio Hi of the spectral curve.

6. The optical correction method for spectral calibration of a hyperspectral imager according to claim 5, wherein an acquisition method for the area deviation ratio Ai of the spectral curve, the abnormal peak quantity ratio Gi of the spectral curve comprises:
comparing the measured spectral curve with the standard spectral curve in an X-Y two-dimensional coordinate system; and performing ratio processing between an area enclosed between the measured spectral curve and the standard spectral curve and an area enclosed between the standard spectral curve and an X-axis to obtain the area deviation ratio Ai of the spectral curve;
acquiring, based on the X-Y two-dimensional coordinate system, position point coordinates of each peak in the measured spectral curve, and numbering peak points; similarly, acquiring position point coordinates of each peak in the standard spectral curve, and also numbering peak points;
matching the coordinates of each peak in the measured spectral curve with the coordinates of a correspondingly numbered peak in the standard spectral curve, and if the coordinates of the peak in the measured spectral curve do not match the coordinates of the correspondingly numbered peak in the standard spectral curve, marking the peak in the measured spectral curve as an abnormal peak; counting a number of abnormal peaks among peaks corresponding to the measured spectral curve as well as a number of the peaks in the measured spectral curve; and performing ratio processing between the number of the abnormal peaks and the number of the peaks in the measured spectral curve to obtain the abnormal peak quantity ratio Gi of the spectral curve.

7. The optical correction method for spectral calibration of a hyperspectral imager according to claim 1, wherein an acquisition method for the data point transmission fluctuation parameter FG comprises:
analyzing the transmission data of the data points to obtain a quantity proportion of target time periods and a time deviation ratio of the target time periods; and multiplying the quantity proportion of the target time periods and the time deviation ratio of the target time periods to obtain the data point transmission fluctuation parameter FG; and
an acquisition method for the time deviation ratio of the target time periods comprises:
performing difference processing between the interval time lengths corresponding to all the target time periods and the reference time length separately, and summing absolute values of differences to obtain a time deviation value of the target time periods; and performing ratio processing between the time deviation value of the target time periods and the reference time length to obtain the time deviation ratio of the target time periods; and wherein
comparing the data point transmission fluctuation parameter FG with a data point transmission fluctuation parameter threshold, comprising:
presetting the data point transmission fluctuation parameter threshold as FJ; and
indicating, if the data point transmission fluctuation parameter FG is greater than or equal to the data point transmission fluctuation parameter threshold FJ, that the data point transmission stability during the measurements of the standard light source by the hyperspectral imager is poor; or
indicating, if the data point transmission fluctuation parameter FG is less than the data point transmission fluctuation parameter threshold FJ, that the data point transmission stability during the measurements of the standard light source by the hyperspectral imager is good.

8. The optical correction method for spectral calibration of a hyperspectral imager according to claim 7, wherein an acquisition method for the quantity proportion of the target time periods comprises:
arranging the data points sequentially according to the transmission time points, extracting interval time lengths between the data points, and consolidating all the extracted interval time lengths into an interval time length data set; selecting, from the interval time length data set, an interval time length with a highest frequency of occurrence, and marking the interval time length as a reference time length; matching all the interval time lengths in the interval time length data set separately with the reference time length, and if there is no match, marking interval time periods, corresponding to interval time lengths that do not match the reference time length, as the target time periods;
counting a number of the target time periods and a number of the interval time lengths, and performing ratio processing between the number of the target time periods and the number of the interval time lengths to obtain the quantity proportion of the target time periods.

9. The optical correction method for spectral calibration of a hyperspectral imager according to claim 1, wherein an acquisition method for the period overlap degree value AS comprises:
performing comparative analysis between the detection period corresponding to the abnormal measured spectral curve and the target time period; classifying, based on a comparative analysis result, the abnormal measured spectral curve as a highly overlapping curve, a moderately overlapping curve, or a non-overlapping curve; counting a number of highly overlapping curves and a number of abnormal measured spectral curves, and performing ratio processing between the number of the highly overlapping curves and the number of the abnormal measured spectral curves to obtain a quantity proportion of the highly overlapping curves;
counting a number of moderately overlapping curves, and performing ratio processing between the number of the moderately overlapping curves and the number of the abnormal measured spectral curves to obtain a quantity proportion of the moderately overlapping curves;
acquiring a total overlapping period between detection periods corresponding to all the moderately overlapping curves and target time periods, extracting a time length of the total overlapping period and a time length of the target time periods, and performing ratio processing between the time length of the total overlapping period and the time length of the target time periods to obtain a time length proportion of an overlapping period; and
multiplying the obtained quantity proportion of the highly overlapping curves, the quantity proportion of the moderately overlapping curves, and the time length proportion of the overlapping period to obtain the period overlap degree value AS.

10. The optical correction method for spectral calibration of a hyperspectral imager according to claim 1, wherein comparing the period overlap degree value AS with the period overlap degree threshold, and determining, based on the comparison result, whether the cause for the wavelength shift is poor data point transmission stability, comprise:
indicating, if the period overlap degree value AS is greater than or equal to the period overlap degree threshold, that the wavelength shift is caused by poor data point transmission stability; or
indicating, if the period overlap degree value AS is less than the period overlap degree threshold, that poor data point transmission stability do not cause the wavelength shift.
